(19) United States
(12) Patent Application Publication
(10) Pub. No.: US 2006/0013412 A1
(43) Pub. Date: Jan. 19, 2006

(54) Method and system for reduction of noise in microphone signals

(76) Inventor: Alexander Goldin, Haifa (IL)

Correspondence Address: BIRCH STEWART KOLASCH & BIRCH, PO BOX 747, FALLS CHURCH, VA, 22040-0747, US

(21) Appl. No.: 10/892,174

(22) Filed: Jul. 16, 2004

(51) Int. Cl. H04B 15/00; H04R 3/00

(52) U.S. Cl. 381/94.1; 381/92

(57) ABSTRACT

A method for processing noisy electric signals, particularly microphone signals, to produce a processed noise reduced signal, is disclosed. Noise reduction is effected by subtracting from a main (front) digital signal a filtered rear signal obtained through an application of continuously adaptable filter coefficients to a rear digital signal. The filter coefficients are supplied by adapting means configured to impose optimal selective constraints on said coefficients, depending on a selected operative mode (either a far talk mode or a close talk mode). According to preferred embodiments of the method, each of the front and rear digital signals is split into a number of frequency subband signals. Each pair of signals belonging to the same subband is processed separately, all processed subband signals being combined into a single noise-reduced output signal. A system for implementing various embodiments of the proposed method is also disclosed.

### BACKGROUND OF THE INVENTION

1. Field of the Invention

This invention relates generally to the fields of directional microphones, microphone arrays, noise reduction and sound enhancement.

2. Description of the Related Art

Widely used omnidirectional microphones pick up sounds (including various interferences) coming from different directions equally well. It means that noise, echoes, room reverberation and other interferences can significantly degrade quality of signals recorded by such microphones. In order to improve a signal-to-noise ratio (that is a ratio between levels of a useful signal and interfering signals picked up by a microphone), a wide range of means for reduction of noise in microphone signals has been developed.

One of the simplest and widely used approaches to improve the signal-to-noise ratio (SNR) for microphone signals is represented by directional microphones. The directional microphones attenuate sounds coming from particular directions, so that in case interferences are coming from directions, different from that of the signal of interest, they can be attenuated, with a proportionate SNR improvement.

By far the most popular type of the directional microphone is a first order gradient type microphone. This type of microphone can be designed employing acoustic or electronic means. FIG. 1 shows a general scheme of a simple prior art electronic directional microphone generally indicated as 5PA. The directional microphone 5PA comprises two omnidirectional microphones 10 spaced apart by a distance d along a microphone axis A-A coincident with an expected direction of a sound wave S₀(t) carrying a useful signal. The microphone 10F receiving first the sound wave S₀(t) is usually termed a front microphone, while the other microphone 10R is termed a rear microphone. The distance d between the microphones 10 has to be large enough to provide a detectable phase shift for low frequencies. At the same time, said distance must be less than half of the shortest acoustic wavelength in the operative frequency range to avoid spatial aliasing (see Clarkson, Peter M., Optimal and Adaptive Signal Processing, CRC Press, 1993). This corresponds to usable distances between the front microphone 10F and the rear microphone 10R in the range of 10 to 40 mm.

The prior art electronic directional microphone further includes: a delay line 12 receiving an output signal R(t) of the rear microphone 10R and producing a signal R(t−τ) (delayed in respect to the signal R(t) by a preset time delay τ); and a subtracter-adder 14 for subtracting the signal R(t−τ) from an output signal F(t) of the front microphone 10F.

In a particular case of a sound wave S(t) of unit amplitude and frequency ƒ forming an angle Θ with the microphone axis A-A, an output of such directional microphone is given by the following equation:
D(ƒ,Θ)=e^{-j2πƒt}(1−e^{-j2πƒ(τ+T cos(Θ))}), (1)
where Θ, τ, ƒ are as specified above, T=d/V_{sound} is a sound propagation time between the microphones 10F, 10R, and V_{sound} is the sound velocity. Taking the magnitude of Eq. 1 yields
|D(ƒ,Θ)|=2|sin(πƒ(τ+T cos(Θ)))| (2)

Assuming a relatively small distance between the microphones and a small delay (ƒd/V_{sound}<<1 and ƒτ<1), we obtain:
|D(ƒ,Θ)|=2 πƒ(τ+T cos(Θ)) (3)

Varying the delay τ between 0 and T, it is possible to get, using the directional microphone 5PA shown in FIG. 1, different polar patterns. For example, τ=0 leads to a bi-directional microphone, τ=T leads to a cardioid pattern, τ=0.5T leads to a super-cardioid pattern.

One can see from Eq. 3 that, by varying τ between 0 and T, it is possible to steer the null in the back plane between 90° and 270°. The null cannot be moved to the front plane, and thus, the signal coming from front directions with θ between −90° and 90° cannot be canceled.

In principle, it is possible to make the delay τ adjustable. The choice of an optimal delay τₒₚₜ depends on the acoustic conditions such as the room reverberation as well as a number, spectral content and a direction of interfering signals. If an appropriate digital signal processor (DSP) is used to perform the delay and subtract operations, then τ may be adjusted automatically to provide the best directivity according to some criteria. However, even with this addition, noise reduction effectiveness of the simple directional microphone of FIG. 1 is limited in many important respects.

For example, in case when interferences have different spectral contents, the optimal delay τₒₚₜ can be different for different frequency bands. Thus, in this case uniform delay in the whole frequency range does not allow to achieve the maximal possible SNR improvement. Further, it follows from Eq. 3 that different values of τ correspond to different front (θ=0) sensitivities inside 6 dB range. Such difference must be automatically compensated to provide constant frequency response.

Eq. 3 shows also that for a fixed τ sensitivity is proportional to the frequency. If a flat frequency response is required, such proportionality should be compensated accordingly. For a small distance between the microphones (where Eq. 3 is valid) such compensation can be achieved by multiplying the output in the frequency domain by the factor 1/ƒ. A problem with such normalization arises, when short time RMS values of sound pressure levels on the two microphones 10 are not equal. This happens for example when the distance between the microphones 10 and the sound source becomes comparable to the distance d between the microphones, so that a “far field” assumption is not valid. A resulting excessive low frequencies amplification due to multiplication by 1/ƒ is called “a proximity effect”. Another example of insufficiency of the described normalization is wind turbulences, when short time RMS values of sound pressure levels on the two microphones fluctuate independently.

A further problem arises in cases of a mismatch between sensitivities of two microphones serving as parts of the described directional microphone. For all such cases the normalized output is given as
D_{q}(ƒ,Θ)=e^{-j2πƒt}(1−qe^{-j2πƒ(τ+T cos(Θ))})/ƒ, (4)
where the value of q indicates the degree of the mismatch. Division by ƒ corresponds to a normalization that is necessary to provide a flat frequency response corresponding to an ideal case (q=1). For zero delay τ=0 and the front sound direction Θ=0 the output amplitude is given by
|D_{q}(ƒ)|=|1−qe^{-j2πƒT}|/ƒ.
The frequency response of such microphone relative to the ideal one (q=1) is correspondingly given as

$${B}_{q} ( f ) = \frac{\vert {D}_{q} ( f ) \vert}{\vert D ( f ) \vert} = \frac{\vert 1 - q {ⅇ}^{- j2π fT} \vert}{\vert 1 - {ⅇ}^{- j2π fT} \vert} \qquad ( 5 )$$

Eq. 5 shows that, depending on the mismatch q, there may be a significant excessive amplification of low frequencies. For example, for the distance between the microphones equal to 15 mm and relatively small mismatches q=0.9 (expressed in decibels 20 log10(0.9)≅−1 dB mismatch), and q=0.8 (20 log10(0.8)≅−2 dB mismatch)
B_{q=0.9} (100 Hz)≅3.7≅11.5 dB
B_{q=0.8} (100 HZ)≅7.3≅17.3 dB

To avoid or to alleviate the described and other disadvantages and/or limitations of the simple directional microphone system, many more elaborate methods and systems for processing electrical signals derived from omnidirectional microphones have been designed. U.S. Pat. No. 4,653,102 discloses a system for reduction of noise in microphone signals in a far talk mode by employing two directional microphones and a microcomputer for performing a fast Fourier transform of received signals in order to go from the time domain to the frequency domain, said transform being followed with an area and phase sorting aimed at improving SNR for a wanted sound in a well-defined area, and with an inverse fast Fourier transform. Use of the Fourier transform and the inverse Fourier transform in combination with a manipulation of frequency domain data to produce a noise-reduced signal is described also in U.S. Pat. No.6,668,062.

U.S. Pat. No. 5,182,774 discloses a headset supplied with an earcup and means for generating the anti-noise signal from the microphone signal obtained from a directional microphone, which detects and transduces the acoustical pressure within the earcup cavity. Another headset design that utilizes active noise cancellation and a booster circuit to compensate for low frequency losses when active noise cancellation is in operation is presented in U.S. Pat. No. 5,604,813.

The system described in U.S. Pat. No. 5,664,021 uses a combination of two directional microphones, mixing circuitry, and control circuitry to simulate a signal that would be generated by a single directional microphone pivoted to direct its maximum response at the acoustic signal as the acoustic signal moves about the environment. According to U.S. Pat. No. 6,584,203A, tracking a moving noise source can be performed with an aid of a second-order adaptive differential microphone array (ADMA).A subband implementation of the ADMA can be used for tracking a different moving noise source for each different frequency subband.

A dual microphone noise reduction system intended for use in mobile phones and employing a far-mouth microphone in conjunction with a near-mouth microphone is disclosed in U.S. Pat. No. 6,549,586. Speech enhancement is attained by including spectral subtraction algorithms using linear convolution, causal filtering and/or spectrum dependent exponential averaging of the spectral subtraction gain function.

U.S. Pat. No. 5,917,921 describes a noise reducing microphone apparatus having a pair of microphone units and an adaptive noise canceller receiving a primary input from one of the microphone units and a reference input from another microphone unit. In the adaptive noise canceller, the reference input is subtracted from the primary input through an adaptive filter, which adaptive filter is adaptively controlled by an output signal resulted from the subtraction in such a way as to minimize an output power of the system.

Notwithstanding a substantial progress in regard to noise reduction achieved in modem microphone systems through an application of various methods of digital signal processing, a long-felt need still exists for versatile and cost-effective microphone systems capable to provide sufficient noise reduction and sound enhancement of microphone signals in various far-talk and/or close-talk applications.

### BRIEF SUMMARY OF THE INVENTION

Accordingly, the main object of this invention is to provide a method and a system for reduction of noise in microphone signals, said method and system of the invention possessing the following advantageous features:
a) an improved noise canceling when the system is used in any of the close and far talk modes;
b) an automatic compensation for different frequency response of the microphones;
c) a reduced sensitivity to wind turbulence;
d) an automatic compensation or control of the proximity effect;
e) minimal distortions of the signal of interest irrespective to the level of the noise or interfering sound.

It is another object of the present invention to provide a compact microphone system suitable for mobile applications.

It is a further object of the invention to provide a directional microphone system demanding only relatively simple digital signal processing of input signals suitable for implementation on relatively inexpensive digital signal processors with fixed point arithmetic.

These and other objects of the present invention are achieved primarily by employing a selective approach to digital processing of microphone signals depending on a particular operative mode of the noise reduction system of the present invention, with the main feature of said selective approach consisting in using a specific constraint on digital filtering of one of microphone signals for each of two main operative modes. More precisely, it was found that, when the system of the invention functions in the far talk operative mode, the optimal form of the said constraint consists in making any of the filter coefficients nonnegative. On the other hand, the optimal form of the said constraint when using the close talk operative mode corresponds to limiting a sum of absolute values of the filter coefficients not to exceed a predetermined value.

A basic method implementing the described selective approach and corresponding to the first aspect of the present invention comprises the following main steps:
(a) providing a front digital signal and a rear digital signal by converting to digital form electrical signals from a front microphone and a rear microphone;
(b) producing a filtered rear signal by filtering the rear digital signal through an application thereto of continuously adaptable filter coefficients;
(c) producing a subtracted signal by subtracting the filtered rear signal from the front digital signal; and
(d) continuously adapting said filter coefficients by supplying the rear digital signal and the subtracted signal to adapting means, said adapting means configured to keep any of the filter coefficients nonnegative, when functioning in the far talk operative mode, and/or to restrict the sum of absolute values of the filter coefficients not to exceed a predetermined value, when functioning in the close talk operative mode.

According to a preferred embodiment of the invention, the method of noise reduction in microphone signals further comprises a step (e) of optionally performing additional processing of the subtracted signal. When the far talk mode is employed. such processing preferably comprises:
computing, on the base of the filter coefficients used in step (b), an equalization coefficient;
producing an equalized signal by multiplying the subtracted signal by the equalization coefficient;
computing, on the base of the front digital signal, the rear digital signal and the equalized signal, a scaling coefficient; and
producing a processed signal by multiplying the equalized signal by the scaling coefficient.

According to another preferred embodiment of the method of the invention, each of the digital signals produced on the base of the front and rear microphone signals is split into M frequency subband signals, and steps (b), (c), (d) and (e) are performed in parallel for each group of signals corresponding to one of the subbands. Then all processed subband signals are combined to form a processed noise reduced signal.

In its second aspect the invention provides a system for implementing the described noise-reduction method.

In its simplest version, the system of the present invention comprises a digital signal processor having at least one adaptive processing unit. The or each adaptive processing unit comprises at least:
input terminals for receiving a front digital signal and a rear digital signal; and
an adaptive filtering unit comprising:
   filter means for filtering the rear digital signal through an application thereto of continuously adaptable filter coefficients;
   subtracting means for subtracting a filtered rear signal from the front digital signal; and
   adapting means for receiving the rear digital signal and the subtracted signal; for continuously adapting said filter coefficients; and for supplying the adapted filter coefficients to the filtering means.

The adapting means is advantageously configured to keep any of the filter coefficients nonnegative, when functioning in the far talk operative mode, and/or to restrict the sum of absolute values of the filter coefficients not to exceed a predetermined value, when functioning in the close talk operative mode. The purpose of the constraints employed in each operative mode is to preserve the signal of interest while reducing the interfering signals.

When adapted to implement any or each of the preferred embodiments of the inventive method, the system of the invention can further comprise, in appropriate combinations, such parts, as:
a front microphone and a rear microphone producing a front microphone signal and a rear microphone signal;
a front input channel and a rear input channel, said channels configured to receive the front microphone signal and the rear microphone signal and to convert them into a front input digital signal and into a rear input digital signal;
a band equalizer block configured to receive the filter coefficients from the adaptive filtering unit and to compute, on the base of said filter coefficients, an equalization coefficient;
first multiplication means for producing an equalized signal by multiplying the subtracted signal by the equalization coefficient;
an output level controller configured to receive the front digital signal, the rear digital signal and the equalized signal and to compute, on the base of said signals, a scaling coefficient; and
second multiplication means for producing a processed signal by multiplying the equalized signal by the scaling coefficient.

The preferred embodiments of the invention perform several additional functions, including a normalization of the output signal to compensate reduced sensitivity for low frequencies; turbulence noise reduction; and proximity effect control.

In case the method of the invention includes the steps of splitting digital signals obtained from the front and rear microphone signals into M frequency subband signals and parallel processing each group of signals corresponding to one of the subbands, the digital signal processor of the noise-reduction system further comprises M adaptive processing units; a first splitter for splitting the front input digital signal into M frequency subband signals and a second splitter for splitting the rear input digital signal into M frequency subband signals. Also, the system further comprises means configured for receiving the processed signal from each adaptive processing unit and for combining said processed signals into a processed noise reduced signal.

To adapt the system of the invention for functioning selectively either in the far talk or close talk operative mode, the system is preferably provided with a mode selector configured for selectively generating either a far talk mode selecting signal or a close talk mode selecting signal, wherein the adapting means or each adapting means is further adapted for receiving the selecting signal to trigger the adapting means into a far talk operative mode or a close talk operative mode.

By extending the concept of the present invention from two to a larger number of omnidirectional microphones, second order directivity in the far talk mode can be achieved. In other words, the system of the present invention can be implemented as an autodirective quadruple microphone comprising two pairs of omnidirectional microphones. The adaptive processing unit (or each of M adaptive processing units, in case the above described splitting into M subbands is provided) of such autodirective quadruple microphone is structured into a first processing block and a second processing block. While the second processing block by its structure and functions is similar to the described adaptive processing unit of the basic embodiment of the system, the first processing block may be described as comprising an adaptive filtering unit consisting of two filter blocks and two subtracter-adders, but only one adaptive coefficients block. This means that said adaptive coefficients block receives signals from both filter blocks and, in its turn, supplies filter blocks with filter coefficients identical for both filter blocks.

The above-described and further objects, features and advantages of the present invention will become apparent from the following detailed description of the preferred embodiments taken in conjunction with the following drawings.

### BRIEF DESCRIPTION OF THE DRAWINGS

FIG. 1 shows a general scheme of a prior art electronic directional microphone system;

FIG. 2 shows a general scheme of the first embodiment of the present invention utilizing two microphones;

FIG. 3 is a block diagram of applying means and a digital signal processor for the system shown in FIG. 2;

FIG. 4 is a block diagram of an adaptive processing unit for the digital signal processor of FIG. 3;

FIG. 5 is a block diagram of an output level controller for the adaptive processing unit of FIG. 4;

FIG. 6 shows a general scheme of the second embodiment of the present invention utilizing four microphones;

FIG. 7 is a simplified block diagram of a digital signal processor for the system shown in FIG. 6, and

FIG. 8 is a block diagram of a processing block for the digital signal processor of FIG. 6.

### DETAILED DESCRIPTION OF THE INVENTION

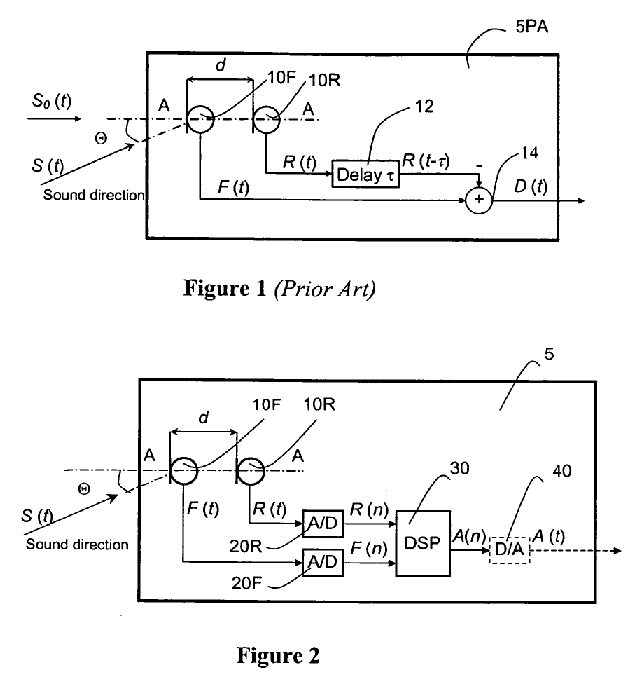

FIG. 2 shows the general scheme of the first embodiment of the noise reduction system according to the invention. The system of the invention is implemented as an improved autodirective dual microphone system of the general type shown in FIG. 1. Similarly to the prior art system, the proposed autodirective dual microphone system comprises two spatially distant microphones 10, a front microphone 10F and a rear microphone 10R.

The front microphone 10F and the rear microphone 10R are connected correspondingly to a front input channel and a rear input channel, each of said channels being represented by an analog-to-digital converter (ADC) 20F, 20R. When the microphones 10F, 10R receive acoustic signals, they correspondingly produce, in response to sound pressure changes, a front microphone signal F(t) and a rear microphone signal R(t), said signals F(t), R(t) being continuous analog electric signals. On receiving signals F(t), R(t), the analog-to-digital converters 20F, 20R of the input channels transform them into front and rear digital signals F(n), R(n).

In their turn, the front and rear input channels are connected to applying means (schematically represented in FIG. 2 as two arrows). Said applying means supply the input digital signals R(n), F(n) to a digital signal processor (DSP) generally designated as 30. The DSP 30 can be implemented on a special digital signal processor, a general-purpose processor, an Application Specific Integrated Circuit (ASIC) and/or by other appropriate digital means.

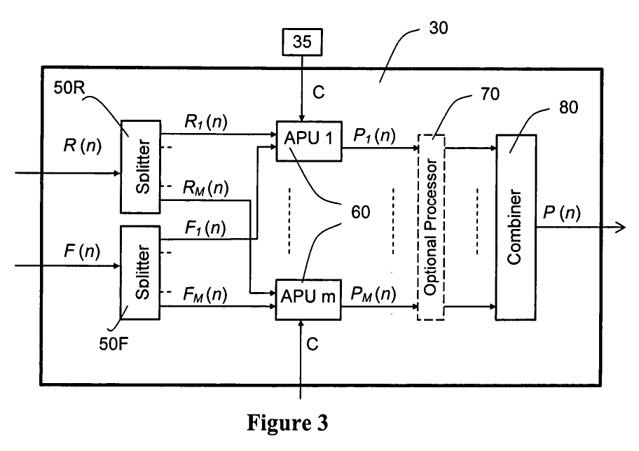

FIG. 3 shows the schematic of a preferred embodiment of the DSP 30. The DSP comprises a first splitter 50F connected to the first input channel (not shown) for receiving therefrom the front digital signal F(n) and a second splitter 50R connected to the second input channel (not shown) for receiving therefrom the rear digital signal R(n). The splitters 50R, 50F split each of the rear and front input digital signals R(n), F(n) into M frequency subband signals, namely into front and rear subband signals {F_{b}(n)}, {R_{b}(n)}. As shall be evident to persons skilled in the art, a proper designed digital IIR or FIR filter bank can be used for implementing the splitters 50R, 50F. Alternatively, FFT based subband decomposition can be used.

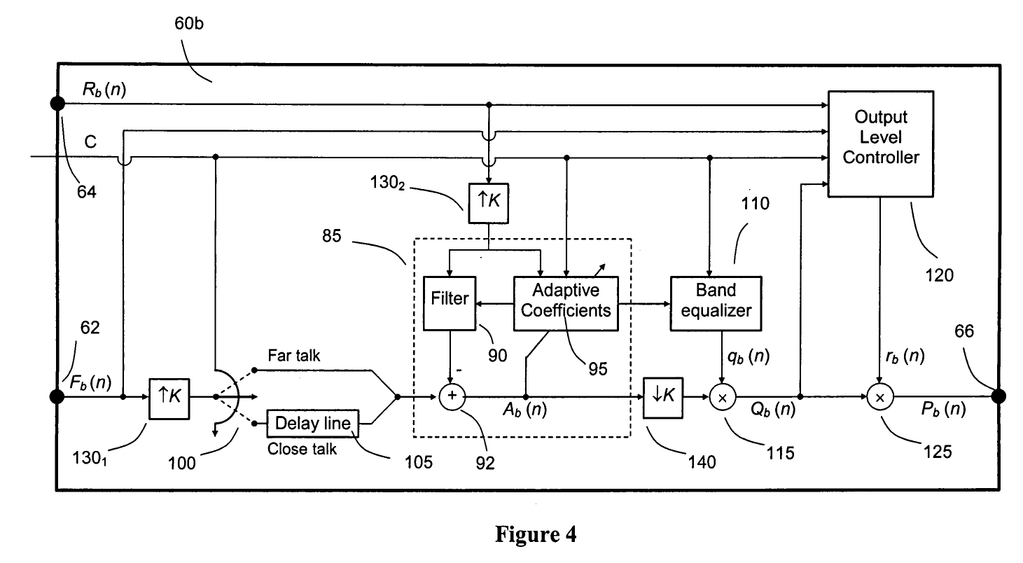

As schematically shown in FIG. 3, the DSP 30 comprises M adaptive processing units (APU) numbered as 60₁ . . . 60ₘ. All adaptive processing units have a similar or identical design and one of them, the APU 60_{b}, is illustrated as a block diagram in FIG. 4. As can be seen from FIG. 4, each APU comprises a first terminal 62 for receiving corresponding front subband signal F_{b}(n) and a second terminal 64 for receiving corresponding rear subband signal R_{b}(n). In other words, as shown in FIG. 3, the first terminal and the second terminal of the first APU 60, receive the first front subband signal F₁(n) from the first splitter 50F and the first rear subband signal R₁(n) from the second splitter 50R, while the first terminal 62_{b} and the second terminal 64_{b} of the bth APU 60_{b} (see FIG. 4) receive correspondingly the bth front subband signal F_{b}(n) from the first splitter 50F and the bth rear subband signal R_{b}(n) from the second splitter 50R. Thus, pairs {R_{b}(n),F_{b}(n)}, that is pairs of a front digital signal and a rear digital signal of corresponding subband signals constitute an input of each of M adaptive processing units 60.

As will be described in detail below, each APU 60 produces optimal directivity signal P_{b}(n) in the frequency subband allotted to said APU. Output subband signals {P_{b}(n)} may be further processed by an optional processor 70 (schematically represented in FIG. 3) before they are combined into the full band noise reduced signal A(n) by a combiner 80. The optional processor 70 is adapted to perform different digital signal processing tasks that are generally performed in frequency subbands. Some of such tasks will be mentioned below.

As can be further seen from FIG. 4, according to a preferred embodiment of the invention, the first input terminal 62 and the second input terminal 64 of the represented APU 60_{b} are correspondingly connected to a first upsampling block 130₁ and to a second upsampling block 130₂, so that the front and the rear digital signals F_{b}(n), R_{b}(n) constitute input signals for said first and second upsampling blocks. As will be explained below, upsampling of the front and rear input signals is necessary to provide sufficient time resolution between signal samples.

The main part of each APU 60 is constituted by an adaptive filtering unit 85, said unit providing all the directivity and noise canceling functionality. The adaptive filtering unit 85 consists of filter means formed as a filter block 90; subtracting means formed as a subtracter-adder 92; and adaptive means formed as an adaptive coefficients block 95. Both the filter block 90 and the adaptive coefficients block 95 are connected to the second input terminal 64 via the second upsampling unit 130₂ for receiving an upsampled rear digital signal, while one of entrances of the subtracter-adder 92 is connected to an exit of the filter block 90 to receive a filtered rear signal therefrom.

According to the preferred embodiment, the proposed noise reduction system of the invention is configured for functioning either in a far talk operative mode or in a close talk operative mode. In the far talk mode the interfering signals are considered to be all signals coming from the rear hemisphere relative to the microphone axis. For all such signals the front microphone signal is delayed relative to the rear microphone signal. In the close talk mode the interfering signals are considered to be all signals that are relatively far away from the microphone. For all such signals the ratio of amplitudes of the front and rear microphone signals are close to unity.

Switching between said operative modes is performed by means of a mode selector 35 (see FIG. 3) adapted to generate a control signal C. The control signal C is generated at either one of two levels, a first of said levels (i.e. high or low level C_{F}) corresponding to the far talk mode selecting signal, and a second one (i.e. low or high level C_{C}) corresponding to the close talk mode selecting signal. As shown in FIG. 4, the control signal C is applied to the adaptive coefficients block 95, the band equalizer 110 and the output level controller 120.

The mode selector 35 also controls, by applying the control signal C, a mode switch 100 that connects, either directly or via a delay line 105, the first upsampling block 130₁ to the second entrance of the subtracter-adder 92. As shown, the delay line 105 is enabled in the close talk mode and bypassed in the far talk mode.

A band equalizer 110 is supplied with an output signal A_{b}(n) from the adaptive coefficients block 95. An equalization coefficient q_{b}(n) from the exit of the band equalizer 110 is applied to one of entrances of first multiplication means formed as a first multiplicator 115. Another entrance of the multiplicator 115 is connected to the exit of the subtracter-adder 92. The connection between the subtracter-adder 92 and the first multiplicator 115 is made via a downsampling block 140.

An equalized signal Q_{b}(n) from the first multiplicator 115 is applied to one of the entrances of an output level controller 120, which controller serves to prevent possible excessive output signal amplification. One of the entrances of the output level controller 120 is connected to the mode selector 35 for receiving therefrom the control signal C. Two remaining entrances of the output level controller 120 are connected to the first and the second input terminals 62, 64 for receiving the first and the second digital input signals.

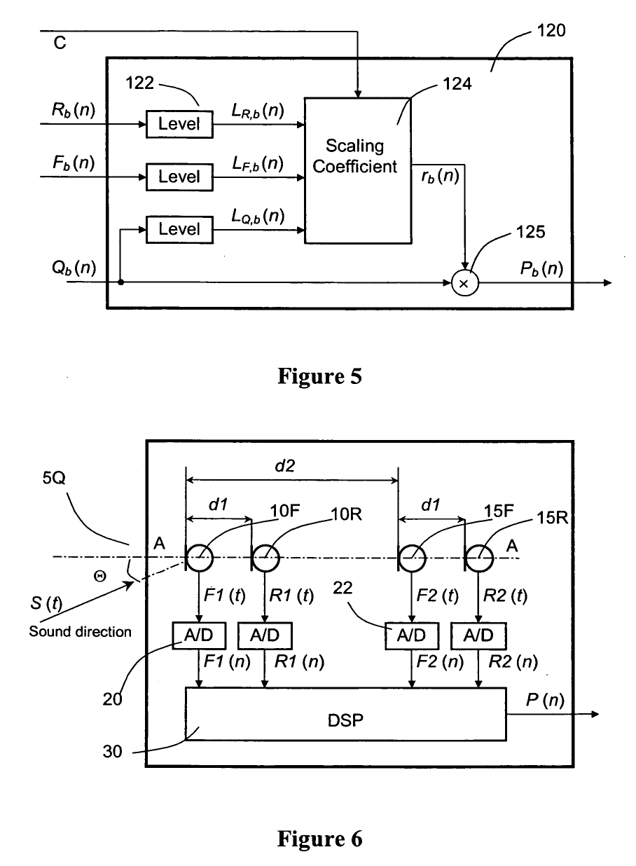

A preferred structure of the output level controller 120 is shown in FIG. 5. The output level controller comprises three similar blocks 122, each said blocks being adapted for receiving one of the rear input signal R_{b}(n), the front input signal F_{b}(n) or the equalized signal Q_{b}(n) and for determining a level of a received signal.

The output level controller 120 comprises also a scaling coefficient calculator 124 performing the computation of the scaling coefficient r_{b}(n), as will be described in more detail below. As can be seen from FIG. 4, the scaling coefficient is applied to one of the entrances of a second multiplicator 125, with another of its entrances being connected to the exit of the multiplicator 115 (see FIG. 4) for receiving therefrom the equalized signal Q_{b}(n). The processed signal P_{b}(n) produced by the second multiplicator 125 is applied to the output terminal 66 of the APU 60b.

The band equalizer 110, the output level controller 120 and two multiplicators 115, 125 constitute a preferred embodiment of processing means of each of the APU 60.

The processed signals P_{b}(n) from each of the APU 60 are fed into a combiner 80 that produces a full band digital output signal P(n) (see FIG. 3). If additional processing of the processed subbband signals P_{b}(n) is desirable, it can be accomplished by an optional processor 70. Examples of such processing include but not limited to noise suppression, multiband signal compression, time-scale speech modification, echo canceling, etc.

Functioning of the APU 60b in the far talk and close talk operative modes according to a preferred version of the method of the invention will be now described with reference to FIG. 4.

First, the functioning of the APU in the far talk operative mode will be considered.

Far Talk Operative Mode

As explained above, the simultaneous switching of all APU 60 into the far talk mode is performed by a generation by the mode selector 35 of the control signal C at the first preset level C_{F} corresponding to this mode. Setting the level of the control signal to the C_{F} can be performed by an operator of the system of the invention by means of a corresponding switch or button (not shown) provided in the mode selector 35 or by any other appropriate means, i.e. from a keyboard, from some distant control system, etc. The generation of the C_{F} signal also results in switching on the output level controller 120 and in bypassing of the delay line 105 (that is in connecting the upsampling block 130₁ directly to the subtracter-adder 92 of the adaptive filtering unit).

In the far talk mode the delay line 105 is bypassed and the adaptive filter length is set as
L=N+1, (6)
where N is proportional to the sound propagation time between the microphones 10. N can be calculated as
N=[d Rₛ/V_{sound}], (7)
where d is the distance between the microphones, Rₛ is the sampling rate of analog-to-digital converters 20, V_{sound} is the sound velocity in the air and [] denotes here the operation of truncation to the nearest integer value.

As can be seen from FIG. 4, the front and rear digital signals F_{b}(n), R_{b}(n) supplied correspondingly to the first and second input terminals 62, 64 are first upsampled in the first and second upsampling blocks 130₁, 130₂. The expediency of the upsampling step is explained by that, in order to use lower computational resources, it is preferable to work with the lowest possible sampling rate Rₛ of analog-to-digital converters 20 in the input channels. As explained, for example, in Proakis, John G., Digital Signal Processing. Principle, Algorithms and Applications, Prentice-Hall, 1996, for correct operation without spectral aliasing, sampling rate Rₛ must exceed twice the highest frequency in a signal being digitized. The typical sampling rate used in digital voice communication is 8 kHz, which means that the upper frequency in all analog signals before analog-to-digital conversion must be limited to 4 kHz. However, with such low sampling rates Rₛ the time resolution provided by adjacent samples can be insufficient for the present invention to operate effectively. Indeed, for 8 kHz sampling rate and the distance between the microphones 10 equal to 35 mm, Eq. 7 gives:
N≅[0.035·8000/341]≅[0.8]=0

According to Eq. 6, N=0 corresponds to unit length L of adaptive filter (90), and, hence, no directivity options except a bi-directional microphone are possible in this case. That is why, in order to provide variable directivity options, sampling rates of the digital input signals R_{b}(n), F_{b}(n) first should be increased in upsampling blocks 130 by a factor K to provide better time resolution between samples. For example, for the distance between the microphones 10 equal to 35 mm and upsampling factor K equal to 4
N≅[0.035·4·8000/341]≅[3.3]=3.

This provides enough resolution for most of applications. As shown in the above-cited book of Proakis, upsampling may be accomplished by inserting K zeros between every original sample and filtering the result with a corresponding low-pass digital filter.

The upsampled rear input digital signal is supplied to the filter block 90 of the adaptive filtering unit 85. The filter block 90 filters said rear input digital signal by applying thereto filter coefficients, which are calculated by the adaptive coefficients block 95. The purpose of adaptive filtering is to remove, to a possible degree, interfering signals from the front microphone signal. According to the present invention, specific constraints are imposed on the coefficients of the filter block 90 to guarantee preservation of the main signal coming from the front direction.

As mentioned above, the kind of applied constraints and specific features of some other steps of the method of the invention are determined by the selected operative mode of the noise reduction system.

When the system of the invention functions in the far talk mode, with each new sample n of the input digital signal the adaptive filtering unit 85 performs the following sequence of operations:
1. Computes an estimate \tilde{F}_{b}(n) of F_{b}(n) from the last L samples of R_{b}(n) as:

$${\tilde{F}}_{b} ( n ) = {\sum }_{k = 0}^{L - 1} {W}_{b , k} ( n ) {R}_{b} ( n - k ) . \qquad ( 8 )$$
2. Computes an output sample as the estimation error:
   A_{b}(n)=F_{b}(n)−\tilde{F}_{b}(n). (9)
3. Updates the filter coefficients to reduce the average output power E{A_{b}²(n)} with the following constraint: all filter coefficients are nonnegative.

In the formulae above an index b corresponds to the bth frequency subband.

Step 1 of filtering is performed by the filter block 90; Step 2 of subtracting the filtered rear signal from the front digital signal F_{b}(n) is performed by the subtracter-adder 92; and Step 3 of adapting (by updating) the filter coefficients is performed by the adaptive coefficients block 95. In the preferred embodiment of the present invention Step 3 is performed using a kind of Normalized Least Mean Squares (NLMS) algorithm (see the above-cited Clarkson book) as:

$${W}_{b , k} ( n ) = {W}_{b , k} ( n - 1 ) + \frac{α {A}_{b} ( n )}{{μ}_{b} ( n )} {R}_{b} ( n - k ) , \\ k = 0 … L - 1 \qquad ( 10 )$$

where μ_{b}(n) is a normalization factor depending on the amplitude of the signal and α is so-called adaptation constant that defines the trade-off between adaptation speed, stability and filter coefficient error in the presence of noise. In the classical NLMS algorithm the normalization factor μ_{b}(n) is computed as

$${μ}_{b} ( n ) = {\sum }_{k = 0}^{L - 1} {R}_{b}^{2} ( n - k ) \qquad ( 11 )$$

In the preferred embodiment of the present invention the normalization factor μ_{b}(n) is computed as
μ_{b}(n)=L·max(γ·μ_{b}(n−1),R_{b}(n))², 0<γ<1 (12)

Such normalization factor works like a peak detector, where γ defines how fast the peak value is forgotten. Similar to Eq. 11, μ_{b}(n) computed according to Eq. 12 reduces the adaptation step when the signal is strong. However, it reacts faster and it is easier to compute.

In the preferred embodiment of the present invention the following constraint is imposed on filter coefficients W_{b,k} in the far talk mode: all filter coefficients are forced to be nonnegative after every filter update:
W_{b,k}(n)=max(W_{b,k}(n), 0), k=0 . . . L−1 (13)

The output sample computed according to Eq. 8 represents a subtracted signal A_{b}(n), which signal is supplied from the adaptive filtering unit 85 to the downsampling block 140. Also, as shown in FIG. 4, the same signal A_{b}(n) is supplied to the adaptive coefficients block 95 to enable the computation of the filter coefficients according to Eq. (14).

In the far talk mode the subtracted signal A_{b}(n) corresponds to an output signal from a directional microphone of a differential type with directivity pattern changing according to current conditions. According to Eq. 3 for small distances between the microphones 10, an amplitude of such signal grows linearly with frequency. Therefore the output of such directional microphone must be equalized to provide a flat frequency response for far sounds coming from the front directions with Θ=0. According to the method of the present invention, such equalization is performed by multiplying the subtracted signal of every filter block 90 by dynamically changing equalization coefficient depending on the current filter coefficients. The equalization coefficient q_{b}(n) is supplied by the band equalizer 110. In the preferred embodiment of the invention said coefficient is computed as:

$${q}_{b} ( n ) = \frac{1}{\vert 1 - {\sum }_{k = 0}^{L - 1} {\overline{W}}_{b , k} ( n ) \cdot {ⅇ}^{- j2π {\overline{f}}_{b} ( Δτ \cdot k + d / {V}_{sound} )} \vert} , \qquad ( 15 )$$

where coefficients of bth filter W_{b,k} are normalized to sum to 1 as

$${\overline{W}}_{b , k} ( n ) = \frac{{W}_{b , k}}{{\sum }_{i = 0}^{L - 1} {W}_{b , i} ( n )}$$

and \overline{ƒ}_{b} is the central frequency of bth frequency subband. In the preferred embodiment \overline{ƒ}_{b} is computed as.

$${\overline{f}}_{b} = \frac{{f}_{b}^{+} + {f}_{b}^{-}}{2} ,$$

where ƒ_{b}⁺, ƒ_{b}⁻ are respectively upper and low cutoff frequencies of the corresponding bandpass filter used in the splitters 50. Detailed mathematical substantiation for computing the equalization coefficient according to Eq. 15 is given in Appendix.

As was already mentioned, the filter coefficients used in the computation of the equalization coefficient q_{b}(n) are supplied to the band equalizer 110 from the adaptive coefficients block 95 of the adaptive filtering unit 85.

Equalization coefficient q_{b}(n) is calculated in the far field assumption of equal sound pressure level on both microphones 10. If it is not the case, multiplication by q_{b}(n) can lead to excessive output signal amplification. For example, relatively small distance between the microphone and the sound source (e.g. mouth) can lead to significantly larger sound pressure on the front microphone. Air turbulences caused by wind can be another reason for random sound pressured level differences on the microphones. The prevention of a possible excessive output signal amplification caused by different levels of sound pressure on microphones 10 when working in the far talk mode is ensured according to the invention with the aid of the output level controller 120, which becomes active on receiving the appropriate control signal C_{F}.

The excessive amplification is eliminated by restricting the level of processed signal P_{b}(n) at the output terminal 66 of the APU 60 to be not greater than the maximal level of the largest of the raw front and the rear input signals F_{b}(n), R_{b}(n) supplied to the corresponding blocks 122 of the band equalizer 120 (see FIGS. 4, 5). In the preferred embodiment of the present invention the restriction is effected by multiplying (by means of the second multiplicator 125) the equalized signal Q_{b}(n) by a scaling coefficient r_{b}(n) computed in the scaling coefficient calculator 124 as
r_{b}(n)={square root over (min(1, max(L_{F,b}(n),L_{R,b}(n)/L_{Q,b}(n)))}, (16)
where L_{F,b}(n),L_{B,b}(n),L_{Q,b}(n) are corresponding instantaneous levels of the digital input signals and the equalized output signal, said levels being determined by corresponding blocks 122 and supplied to the scaling coefficient calculator 124.

While a signal level may be defined in different ways, when a preferred embodiment of the blocks 122 is employed, a level of a signal X(n) is calculated as
L_{X}(n)=max (β·L_{X}(n−1), |X(n)|),
where the coefficient β<1 depends on the sampling rate and is chosen so that L_{X} “forgets” 90% of its peak value in about 5 ms.

The processed signal P_{b}(n) from the second multiplicator 125 is supplied to the output terminal 66 of the APU 60b.

A digital signal P(n) produced as the output of the DSP 30 may be further transformed into analog signal P(t) by a digital-to-analog converter 40 (FIG. 2). The signal P(t) then can be used as an output A(t) of a standard microphone. Alternatively, the signal P(n) may be used in digital form for further processing.

Close Talk Operative Mode

The system is switched into the close talk mode by the generation, by the mode selector 35, of the control signal C at the second preset level C_{C} corresponding to this mode. Such switching results in enabling of the delay line 105 and disabling of the band equalizer 110 and the output level controller 120.

Because in the close talk mode some parts of the APU 60 (i.e. upsapmling and downsampling blocks 130, 140, the subtracter-adder 92, etc.) perform their functions in a way identical to that in the far talk mode, only specific features of the close talk mode will be described in detail below.

Filter block 85 functions essentially in the same regime; however, due to enabling of the delay line 105 corresponding to N samples, the length L of the adaptive filter increases to
L=2N+1 (17)

Another specific feature consists in a change of the constraint imposed by the adaptive coefficients block 95. For the close talk mode the sum of absolute values of the filter coefficients shall not exceed a predetermined value. In other words, said sum is limited after every filter update to some value Uₘₐₓ>1:

$$U = {\sum }_{i = 0}^{L - 1} \vert {W}_{k} ( i ) \vert \\ {W}_{k} ( i ) = {W}_{k} ( i ) \cdot min ( 1 , {U}_{max} / U ) \qquad ( 18 )$$

In the preferred embodiment of the present invention value Uₘₐₓ is set between 1.5 and 3.

Further, because the band equalizer 110 and the output level controller 120 are disabled, no equalization coefficient q_{b}(n) and scaling coefficient r_{b}(n) are generated, so that the processed signal P_{b}(n) supplied to the output terminal 66 of the APU 60b is the same as the signal A_{b}(n).

The detailed mathematical substantiation of the computational scheme according to the present invention (as specified by Eq. 8-18) is supplied in Appendix.

According to the above-described embodiment of the present invention directivity is achieved by subtracting a filtered version of the rear digital input signal R_{b}(n) representing the rear microphone signal from the front digital input signal F_{b}(n) representing the front microphone signal. This, first order directivity corresponds to the first derivative of the sound pressure along the microphone axis. In some applications (related mainly to the far talk mode) first order directivity does not provide enough improvement of signal-to-noise ratio, so that second order directivity would be desirable. Such second order directivity can be achieved according to the principles of the present invention by combining outputs of two first order directional microphones (either conventional microphones or ones designed according to the present invention). However, this solution requires accurate matching of phase characteristics of the directional microphones, which matching is, as a rule, difficult to achieve.

More advantageous way to achieve the second order directivity in the far talk mode consists in an appropriate extension of the concept of the present invention from two to a larger number of microphones. An embodiment of the proposed system implemented as an autodirective quadruple microphone generally indicated as 5Q is presented in FIG. 6. The inventive quadruple microphone 5Q comprises two pairs of omnidirectional microphones. In other words, in addition to the first microphone pair consisting of the front microphone 10F and the rear microphone 10R, the system presented in FIG. 6 comprises an additional microphone pair consisting of an additional front microphone 15F and an additional rear microphone 15R. Microphones inside each pair are separated by a distance d1, while the microphone pairs are separated by a distance d2. In a general case, the distance d1 can differ from the distance d2.

Similarly to the previously described noise-reduction system of FIG. 2, in the system of FIG. 6 the front microphone 10F and the rear microphone 10R are connected correspondingly to the front input channel and the rear input channel, each of said channels being represented by a corresponding analog-to-digital converter 20. In the same way, the additional front microphone 15F and the additional rear microphone 15R are connected correspondingly to the additional front input channel and the additional rear input channel, each of said channels being represented by a corresponding additional analog-to-digital converter 22. All front and rear input digital signals F1(n), R1(n), F2(n), R2(n) produced by the analog-to-digital converters 20, 22 on receiving analog electric signals F1(t), R1(t), F2(t), R2(t) are applied via applying means to a digital signal processor (DSP) 30.

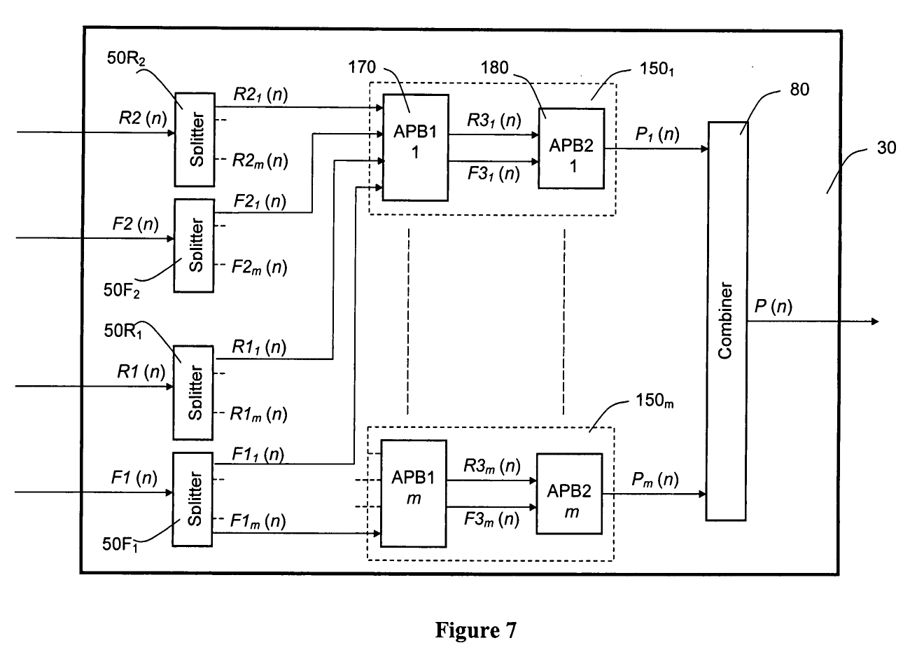

FIG. 7 shows the schematic of a preferred embodiment of the digital signal processor 30 corresponding to the noise reduction system of FIG. 6 implementing the autodirective quadruple microphone system. Similar to the DSP of the autodirective dual microphone system shown in FIG. 3, the DSP shown in FIG. 7 comprises two splitters 50F₁, 50R₁ and 50F₂, 50R₂ for each microphone pair 10, 15. The front and rear digital signals F1(n), R1(n), F2(n), R2(n) are splitted by the splitters 50 into M frequency subband signals, namely into front and rear subband signals {F1_{b}(n)}, {R1_{b}(n)} and into additional front and rear subband signals {F2_{b}(n)}, {R2_{b}(n)}.

As schematically shown in FIG. 7, the DSP 30 in this embodiment of the proposed system comprises M second order adaptive processing units (APU) 150 having identical design and the combiner 80 similar or identical to that shown in FIG. 3. Optional processor 70 is omitted in FIG. 7 for simplicity, while the mode selector 35 generating the control signal C is not used for the reason that this embodiment is intended only for use in the far talk operative mode.

Each APU 150 of the autodirective quadruple microphone system differs from the APU 60 in that the APU 150 consists of a first adaptive processing block (APB1) 170 and a second adaptive processing block (APB2) 180. Each adaptive processing block 170, 180 operates according to the method of the present invention and corresponds to one (a first or a second) stage of processing digital signals representing 4 microphone signals F1(t), R1(t,) F2(t), R2(t). The first processing block 170 is fed with two pairs of subband signals and at its output it generates two signals F3, R3, said signals corresponding to two first order autodirective dual microphone signals with matching phase characteristics. Consequently, said two signals are fed into the second processing block 180 producing an output signal corresponding to a second order directional microphone signal.

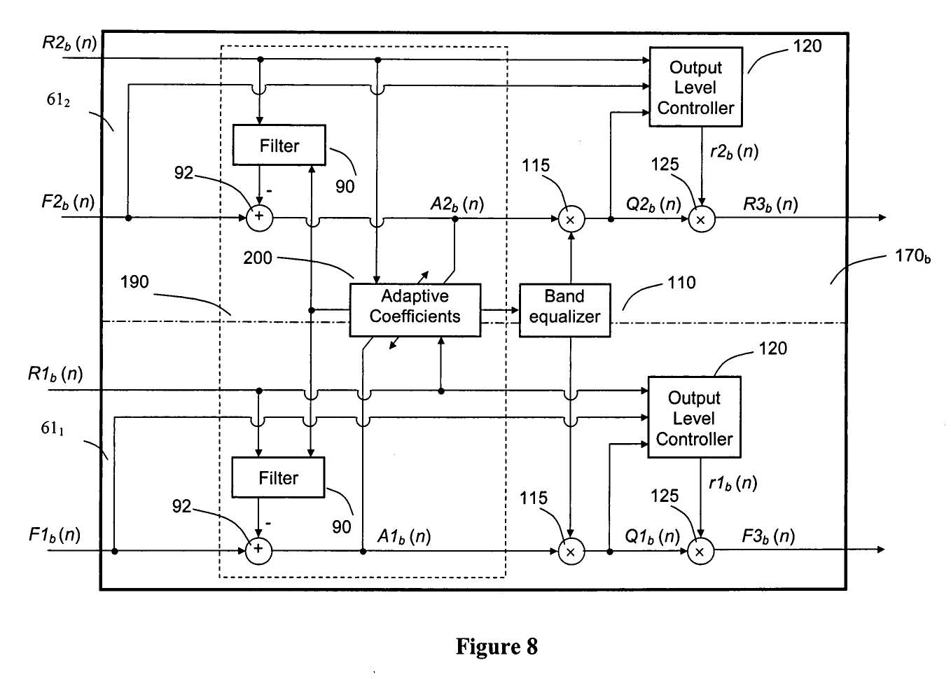

FIG. 8 shows the schematic of the first processing block 170_{b} belonging to the APU 150_{b}. As will become clear from the following description, the block 170_{b} functions as two parallel APU 61₁, 61₂ (similar to the above-described APU 60) with shared adaptive filter coefficients.

The APU 61₁ of the first processing block 170_{b} comprises:
the first and second terminals (not shown) for receiving correspondingly the front subband signal F1_{b}(n) and the rear subband signal R1_{b}(n);
the adaptive filtering unit formed by the filter block 90; an adaptive coefficients block 200 and the subtracter-adder 92;
the processing means comprising the band equalizer 110, the output level controller 120, the first multiplicator 115 and the second multiplicator 125.

Similarly, the second of said two APUs, APU 61₂, of the first processing block 170_{b} comprises:
the additional first and second terminals (not shown) for receiving correspondingly the additional front subband signal F2_{b}(n) and the additional rear subband signal R2b(n);
the adaptive filtering unit formed by the filter block 90; the adaptive coefficients block 200 and the subtracter-adder 92;
the processing means comprising the band equalizer 110, the output level controller 120₂ the first multiplicator 115 and the second multiplicator 125.

With an exception of the band equalizer 110 and the adaptive coefficients block 200 (which will be discussed in more detail below), all parts of the first and second APU 61₁, 61₂ of the first processing block 170_{b} are equivalent or identical in their design and functions to the correspondent parts of the of the APU 60_{b} described above with reference to FIG. 5. Therefore, there is no need in their detailed description. It is sufficient to note that the first and second APU 61₁, 61₂ produce at their output terminals correspondingly a first processed signal P1_{b}(n) and a second processed signal P2_{b}(n) in a way generally similar to the production of the processed signal P_{b}(n) described above with reference to FIG. 4.

It may be also noted that, though not shown in FIG. 8, each of the APU 61₁, 61₂ can further comprise two upsampling blocks 130 and one downsampling block 140, all said blocks having design, connections and functions similar or identical to those of the corresponding blocks of the above-described APU 60_{b}.

As shown in FIG. 8, the band equalizer 110 and the adaptive coefficients block 200 are shared by both APU 61₁, 61₂. This means that the adaptive coefficients block 200 receives both the front subband signal F1_{b}(n), the rear subband signal R1_{b}(n) and a subtracted signal A1_{b}(n) from the first APU 61₁ and the additional front subband signal F2_{b}(n), the additional rear subband signal R2b(n) and a subtracted signal A2_{b}(n) from the second APU 61₂. Operation of the common band equalizer 110 is similar to that of the above-described band equalizer 110, the only difference being that in the first processing block 170 the band equalizer 110 supplies with the equalization coefficient q_{b}(n) first multiplicators 115 of both APU 61₁, 61₂.

The first processing block 150 may be alternatively viewed as comprising an adaptive filtering unit 190 consisting of two filter blocks 90, 90, two subtracter-adders 92, 92, but only one adaptive coefficients block 200. With each new sample n, adaptive filtering unit 190 performs the following sequence of four operations:
1. Computes estimates \tilde{F}1_{b}(n), \tilde{F}2_{b}(n) of F1_{b}(n), F2_{b}(n) from the last L samples of R1_{b}(n), R2_{b}(n) as:

$$\tilde{F} {1}_{b} ( n ) = {\sum }_{k = 0}^{L - 1} {W}_{b , k} ( n ) {R1}_{b} ( n - k ) \\ \tilde{F} {2}_{b} ( n ) = {\sum }_{k = 0}^{L - 1} {W}_{b , k} ( n ) {R2}_{b} ( n - k ) \qquad ( 19 )$$
2. Computes output samples as the estimation errors:
   A1_{b}(n)=F1_{b}(n)−\tilde{F}1_{b}(n) (20)
   A2_{b}(n)=F2_{b}(n)−\tilde{F}2_{b}(n)
3. Computes filter update normalization constant as:
   μ_{b}(n)=L·max (γ·μ_{b}(n−1), R1_{b}(n), R2_{b}(n))²
   0<γ<1
4. Updates filter coefficients

$$\begin{matrix}{W}_{b , k} ( n ) = {W}_{b , k} ( n - 1 ) + \frac{α}{{μ}_{b} ( n )} ( {A1}_{b} ( n ) \cdot {R1}_{b} ( n - k ) + {A2}_{b} ( n ) \cdot {R2}_{b} ( n - k ) ) \\ k = 0 … L - 1\end{matrix} \qquad ( 21 )$$

It is evident from the above expressions that general principles of operation of the adaptive filtering unit 190 are equivalent to those of the adaptive filtering unit 85 in the far talk operative mode. However, computations of the estimates and the output samples are conducted independently for signals received from each of the APU 60₁, APU 60₂, while computations of the normalization constant μ_{b}(n) and the filter coefficients W_{b,k}(n) are conducted for data sets including signals received from both APU 60₁, APU 60₂. Correspondingly, Eq. 21 is equivalent to updating the filter coefficients twice for every n.

Using the same filter coefficients for both filter blocks 90 corresponding to the first and second microphone pairs ensures the same phase characteristics of the processed signals. This is important as both the first processed signal P1_{b}(n) and the second processed signal P2_{b}(n) constituting an output of the first processing block 170 are used as input signals for the second processing block 180.

The second processing block 180 of the adaptive filtering unit 160 is equivalent to the APU 60 (shown in FIG. 4) functioning in the far talk mode. For that reason its schematic is almost the same as presented in FIG. 4, but no control signal C and the delay (obtained with the delay line 105) are used. As shown in FIG. 7, the processed signals outputted from the first processing block 170 are correspondingly applied to input terminals of the second processing block 180 as a front digital signal F3_{b}(n) and a rear digital signal R3_{b}(n) (said signals correspond to signals F3₁(n), R3₁(n) for the first APU 150, and to signals F3ₘ(n), R3ₘ(n) for the last, mth APU 150ₘ shown in FIG. 8). On receiving the pair of signals from the corresponding first processing block 170_{b}, each of the second processing blocks 180_{b} produces, in the way described above in relation to the APU 60b, an output signal corresponding to a processed subband signal P_{b}(n).

Then all subband signals are combined in the described manner inside the combiner 80 into a full band processed signal P(n).

When the distances d1 between microphones 10, 15 in each microphone pair and the distance d2 between the first and second microphone pairs are equal (d1=d2), two middle microphones (the rear microphone 10R of the first pair and the additional front microphone 15F of the second, additional pair) coincide in space, so it is possible to eliminate one of them (i.e. the additional front microphone 15F). In this case the microphone signal from the remaining middle microphone 10R is used both as the rear microphone signal R1(t) of the first microphone pair and as the additional front microphone signal F2(t) of the additional microphone pair.

The invented microphone system using two microphones and a digital signal processor offers the following advantages over conventional prior art microphone systems:
improved noise rejection due to fast adaptation of its directive characteristics to the current acoustic conditions;
no on-axis sound distortion;
no “proximity effect” associated with amplification of low frequencies by a standard directional microphone when the distance between the microphone and the sound source becomes comparable to the microphone dimensions;
low sensitivity to wind turbulence noises;
improved noise attenuation comparing to a prior art directive microphone when it is used in a close talk mode;
low implementation cost in terms of computational power and memory consumption;
relatively easy integration into different form factors, mobile or other devices or objects of interior;
low requirements for microphone frequency responses to match each other;
extensibility for building directional microphone systems of higher order.

As for the autodirective quadruple microphone system of the present invention, while conserving all important advantages of the dual microphone system, it can provide much better rejection of interfering sounds.

This description uses several examples to disclose the invention, including its best mode, and also to enable a person skilled in the art to make and use the invention. It will be obvious to those of ordinary skill in the art that various changes and modifications can be made without departing from the spirit and scope of the invention. The patentable scope of the invention is therefore defined by the claims, and it includes other examples that occur to those skilled in the art.

For example, in case requirements for quality of the output processed signal can be made less strict, a step of controlling of the output level of each equalized subband signal Q_{b}(n) can be omitted, with a corresponding simplification of the system of the invention by omitting all output level controllers 120 and all multiplicators 115 associated with said controllers.

Further simplification can be attained by omitting all band equalizers 110 and all associated first multiplicators 115.

Even more substantial simplification (again in cases when a tradeoff between processing quality and costs is permissible) can be achieved by omitting the step of splitting each of the input signals into M subband signals. When said splitting step is not used, the system of the invention can be designed without splitters 50 and the combiner 80. Moreover, only a single adaptive processing unit will be needed.

Further, the method and the system of the invention can be implemented, with all above-listed advantages, not only for processing microphone signals in real time, but also when working in an “off-line” regime, that is when microphone or similar signals are recorded in an appropriate recording medium or memory means. If this is the case, then the steps of receiving and converting the microphone signals are not always necessary for implementing the method of the invention. Correspondingly, the microphones themselves do not constitute necessary parts of the inventive noise-reduction system.

Further, in cases when the input signals are recorded in a digital form, there is no need to supply the system of the invention with any analog-to-digital converters constituting input channels.

All discussed options of simplifying the method and the system of the invention are fully applicable to all described embodiments of the invention, including those corresponding to the autodirective quadruple microphone system presented in FIGS. 6 to 8. Still further simplification is possible in relation to the embodiment corresponding to the autodirective dual microphone system presented in FIGS. 2 to 5. More specifically, instead of using such system selectively in either far talk or close talk modes, it can be adapted for only any one of such operative modes. Evidently, such system will not need the mode selector 35 and the mode switch 100. Moreover, a system intended only for the far talk mode will have no use for the delay line 105, while a system intended only for the close talk mode will not use the band equalizer 1 10 and the output level controller 120.

### APPENDIX

Far Talk Mode

FIG. 4 shows that in the far talk mode the delay line 105 provided for delaying the front signal Fₖ(n) is bypassed. Eq. 6 states that the maximal delay that may be introduced by the adaptive filter (90) is equal to L=N samples where N corresponds to the time propagation between the microphones (10) so that d≅V_{sound}·N/Rₛ. According to Eq. 8, 9 the output amplitude A for a plane wave of frequency ƒ coming from the direction with angle Θ is given as

$$\begin{matrix}{A}_{b} ( f , Θ ) = \vert {F}_{b} - {R}_{b} {\sum }_{i = 0}^{L - 1} {\overline{W}}_{b} ( i ) \cdot {ⅇ}^{- j 2 π f ( Δ τ \cdot i + T ( Θ ) )} \vert \\ T ( Θ ) = d cos ( Θ ) / {V}_{sound} \\ Δ τ = 1 / {R}_{s}\end{matrix} \qquad ( 22 )$$

The corresponding gain is thus given as

$$\begin{matrix}{g}_{b} ( f , Θ ) = {A}_{b} ( f , Θ ) / {F}_{b} \\ = \vert 1 - \frac{{R}_{b}}{{F}_{b}} {\sum }_{i = 0}^{L - 1} {\overline{W}}_{b} ( i ) \cdot {ⅇ}^{- j 2 π f ( Δ τ \cdot i + T ( Θ ) )} \vert \\ = \vert 1 - {\sum }_{i = 0}^{L - 1} {W}_{b} ( i ) \cdot {ⅇ}^{- j 2 π f ( Δ τ \cdot i + T ( Θ ) )} \vert \\ {W}_{b} ( i ) = \frac{{R}_{b}}{{F}_{b}} {\overline{W}}_{b} ( i ) .\end{matrix}$$

For 90°≦Θ≦270° the sound propagation delay between microphones corresponds to T(Θ)≦0. It follows that g_{b}(ƒ, Θ)=0 when i=−T(Θ))/ Δτ and W_{b}(i)=R_{b}/F_{b}. Thus, for sounds originating from the back plane a perfect cancellation is achieved. For a mixture of signals coming from directions with 90°≦Θ≦270° a combination of non-negative W_{b}(i) selected such that

$${\sum }_{i = 0}^{L - 1} {W}_{b} ( i ) = \frac{{R}_{b}}{{F}_{b}}$$

will provide the perfect cancellation. Alternatively, for −90°<Θ<90° and W_{b}(i) restricted to be non-negative, the sound wave is attenuated, but cannot be completely cancelled. For a wave of frequency ƒ coming from front direction (Θ=0) the gain is given by

$${g}_{b} ( f , 0 ) = \vert 1 - {\sum }_{i = 0}^{L - 1} {W}_{b} ( i ) \cdot {ⅇ}^{- j 2 π f ( Δ τ \cdot i + d / {V}_{sound} )} \vert .$$

For a plane incident wave (far field case) and equal sensitivities of microphones 10F, 10R R_{b}=F_{b} so that

$$\begin{matrix}{g}_{b} ( f , 0 ) = \vert 1 - {\sum }_{i = 0}^{L - 1} {\overline{W}}_{b} ( i ) \cdot {ⅇ}^{- j 2 π f ( Δ τ \cdot i + d / {V}_{sound} )} \vert \\ and \\ {\sum }_{i = 0}^{L - 1} {\overline{W}}_{b} ( i ) = 1.\end{matrix} \qquad ( 23 )$$

To provide a frequency response equal for all frequencies of signals with Θ=0, the output for the narrow band signal with frequency ƒ must be multiplied by the equalization coefficient q_{b}(ƒ) that is inverse to the gain (23)

$${q}_{b} = \frac{1}{{g}_{b} ( f , 0 )} .$$

For a wide band signal each frequency is to be normalized differently. Assuming that the gain difference for frequencies inside each band is small enough, the equalization coefficient q_{b}(n) is computed for the band central frequency \overline{ƒ}_{b} as

$${q}_{b} ( n ) = \frac{1}{{g}_{b} ( {\overline{f}}_{b} , 0 )} = \frac{1}{\vert 1 - {\sum }_{k = 0}^{L - 1} {\overline{W}}_{b , k} ( n ) \cdot {ⅇ}^{- j 2 π {\overline{f}}_{b} ( Δ τ \cdot k + d / {V}_{sound} )} \vert} . \qquad ( 24 )$$

Close Talk Mode

In the close talk mode there is no preferred direction. All sounds originating outside a close proximity to the microphone are to be cancelled. Positive delays in Eq. 22 make it possible to cancel sounds arriving from directions [90°, 270°]. To cancel sounds arriving from directions [0°, 90°], computations according to Eq. 22 are modified to include negative delays as follows:

$$\begin{matrix}{A}_{b} ( f , Θ ) = \vert {F}_{b} - {R}_{b} {\sum }_{i = 0}^{L - 1} {W}_{b} ( i ) \cdot {ⅇ}^{- j 2 π f ( Δ τ \cdot ( i - N ) + T ( Θ ) )} \vert \\ L = 2 N + 1\end{matrix} \qquad ( 25 )$$

Introducing a negative delay into the rear microphone signal R_{b}(n) is equivalent to introducing an equivalent positive delay into the front microphone signal F_{b}(n). R_{b}(n). According to the present invention, in the close talk mode the delay line 105 is enabled and the length L of the filter block 90 is computed according to Eq. 17 to incorporate N negative, zero and N positive delays.

For a plane incident wave (distant sounds, far field case) and equal sensitivities of microphones 10F, 10R R_{b}=F_{b}. With real microphones

$$γ {R}_{b} \leq {F}_{b} \leq \frac{1}{γ} {R}_{b} , \qquad ( 26 )$$

where γ<1 defines a maximal sensitivity difference between microphones 10. With good quality microphones γ>0,8 (2 dB). According to the inverse law, the sound pressure amplitude is inversely proportional to the distance to a sound source. Therefore, for sounds generated at zero angle and with ideal microphones 10F, 10R:

$${F}_{b} = \frac{D + d}{D} {R}_{b} = {B}_{D} \cdot {R}_{b} , \qquad {B}_{D} = \frac{D + d}{D} \geq 1$$

for all frequency bands, where D is the distance between the sound source and the front microphone 10F, d is the distance between microphones 100F, 10R. For real microphones

$$γ \cdot {B}_{D} \cdot {R}_{b} \leq {F}_{b} \leq \frac{1}{γ} \cdot {B}_{D} \cdot {R}_{b} ,$$

where γ<1 again defines the maximal sensitivity difference between microphones 10. Coefficients W_{b}(i) of the adaptive filter in Eq. 25 are chosen to provide the minimal output signal amplitude. Due to incorporating delays corresponding to sounds coming from all directions, unconstrained filter coefficients W_{b}(i) may provide complete cancellation of all sounds. Amplitude differences caused by factors B and γ are compensated by scaling the filter coefficients accordingly. This is not the desirable situation as close signals with factor B exceeding some threshold must be preserved. This is achieved by constraining the sum of absolute values of coefficients W_{b}(i). After every filter adaptation step the filter coefficients W_{b}(i) are modified as

$$U = {\sum }_{i = 0}^{L - 1} \vert {W}_{b} ( i ) \vert$$

$${W}_{b} ( i ) = {W}_{b} ( i ) \cdot min ( 1 , {U}_{max} / U )$$

to satisfy the constraints.

I claim:

1. A method for processing noisy electric signals to produce a processed noise reduced signal, the method comprising the steps of:
(a) providing a front digital signal and a rear digital signal;
(b) producing a filtered rear signal by filtering the rear digital signal through an application thereto of continuously adaptable filter coefficients;
(c) producing a subtracted signal by subtracting the filtered rear signal from the front digital signal;
(d) continuously adapting said filter coefficients by supplying the rear digital signal and the subtracted signal to adapting means, said adapting means configured, at least when functioning in one of its operative modes, to keep any of the filter coefficients nonnegative;
(e) producing a processed signal by optionally performing additional processing of the subtracted signal; and
(f) using the processed signal to form the processed noise reduced signal.

2. The method according to claim 1, wherein:
step (b) further comprises upsampling the rear digital signal prior to filtering said signal;
step (c) further comprises upsampling the front digital signal prior to subtracting the filtered rear signal therefrom; and
step (e) comprises downsampling the subtracted signal.

3. The method according to claim 1, wherein step (e) further comprises:
computing, on the base of the filter coefficients used in step (b), an equalization coefficient;
producing an equalized signal by multiplying the subtracted signal by the equalization coefficient;
computing, on the base of the front digital signal, the rear digital signal and the equalized signal, a scaling coefficient; and
producing a processed signal by multiplying the equalized signal by the scaling coefficient.

4. The method according to claim 2, wherein:
step (a) further comprises the steps of:
(g) receiving a front microphone signal and converting it into a front input digital signal;
(h) receiving a rear microphone signal and converting it into a rear input digital signal; and wherein
step (b) is performed using the rear input digital signal or a digital signal derived therefrom as the rear digital signal, while step (c) is performed using the front input digital signal or a digital signal derived therefrom as the front digital signal.

5. The method according to claim 4, wherein:
step (g) further comprises step (i) of splitting the front input digital signal into M frequency subband signals representing front subband signals numbered as 1, 2, . . b, . . . m, where m is an integer equal to or exceeding 2; and
step (h) further comprises step (j) of splitting the rear input digital signal into M frequency subband signals representing rear subband signals numbered 1, 2, . . . b, . . . m;
steps (b) and (c) are performed in parallel for each pair of the bth front subband signal and the bth rear subband signal using the bth front subband signal as the front digital signal and the bth rear subband signal as the rear digital signal; and:
step (f) comprises combining all processed signals resulting from performance of steps (b) to (e) for each said pair of signals to form the processed noise reduced signal.

6. The method according to claim 4 further comprising a step (k) of selectively generating either a far talk mode selecting signal or a close talk mode selecting signal, wherein:
step (d) comprises:
keeping, by the adapting means, any of the filter coefficients nonnegative, when the far talk mode selecting signal is being generated, or restricting the sum of absolute values of the filter coefficients not to exceed a predetermined value when the close talk mode selecting signal is being generated; and
when the close talk mode selecting signal is being generated, the upsampled front digital signal in step (c) is delayed prior to subtracting the filtered rear signal therefrom.

7. The method according to claim 6; wherein:
step (g) further comprises step (i) of splitting the front input digital signal into M frequency subband signals representing front subband signals numbered as 1, 2, . . . b, . . . m, where m is an integer equal to or exceeding 2; and
step (h) further comprises step (j) of splitting the rear input digital signal into M frequency subband signals representing rear subband signals numbered 1, 2, . . . b, . . . m;
steps (b) and (c) are performed in parallel for each pair of the bth front subband signal and the bth front subband signal using the bth front subband signal as the front digital signal and the bth rear subband signal as the rear digital signal; and:
step (f) comprises combining all processed signals resulting from performance of steps (b) to (e) for each said pair of signals to form the processed noise reduced signal.

8. A method for processing noisy electric signals to produce a processed noise reduced signal, the method comprising the steps of:
(a) providing a front digital signal and a rear digital signal;
(b) producing a filtered rear signal by filtering the rear digital signal through an application thereto of continuously adaptable filter coefficients;
(c) producing a subtracted signal by subtracting the filtered rear signal from the front digital signal;
(d) continuously adapting said filter coefficients by supplying the rear digital signal and the subtracted signal to adapting means, said adapting means configured, at least when functioning in one of its operative modes, to keep the sum of absolute values of the filter coefficients not exceeding a predetermined value;
(e) producing a processed signal by optionally performing additional processing of the subtracted signal; and
(f) using the processed signal to form the processed noise reduced signal.

9. The method according to claim 8, wherein:
step (b) further comprises upsampling the rear digital signal prior to filtering said signal;
step (c) further comprises upsampling the front digital signal prior to subtracting the filtered rear signal therefrom; and
step (e) comprises downsampling the subtracted signal.

10. The method according to claim 8, wherein:
step (g) further comprises step (i) of splitting the front input digital signal into M frequency subband signals representing front subband signals numbered as 1, 2, . . . b, . . . m, where m is an integer equal to or exceeding 2; and
step (h) further comprises step (j) of splitting the rear input digital signal into M frequency subband signals representing rear subband signals numbered 1, 2, . . . b, . . . m;
steps (b) and (c) are performed in parallel for each pair of the bth front subband signal and the bth front subband signal using the bth front subband signal as the front digital signal and the bth rear subband signal as the rear digital signal; and:
step (f) comprises combining all processed signals resulting from performance of steps (b) to (e) for each said pair of signals to form the processed noise reduced signal.

11. A noise reduction system, comprising:
output means;
supplying means operatively connected to the output means; and
a digital signal processor comprising at least one adaptive processing unit, wherein the or each adaptive processing unit comprises:
a first input terminal for receiving a front digital signal;
a second input terminal for receiving a rear digital signal;
an adaptive filtering unit comprising:
filter means for filtering the rear digital signal through an application thereto of continuously adaptable filter coefficients;
subtracting means for subtracting a filtered rear signal from the front digital signal and for providing a subtracted signal by subtracting the filtered rear signal from the front digital; and
adapting means for: receiving the rear digital signal and the subtracted signal; continuously adapting said filter coefficients in such a way as to minimize an average energy of the subtracted signal; and supplying the adapted filter coefficients to the filtering means, wherein the adapting means is configured, at least when functioning in one of its operative modes, to keep any of the filter coefficients nonnegative;
processing means for optionally performing additional processing of the subtracted signal; and
an output terminal functionally connected to the processing means and to the supplying means.

12. The system according to claim 11, wherein the or each adaptive processing unit further comprises:
a first upsampling block for upsampling the front digital signal before applying it to the subtracting means;
a second upsampling block for upsampling the rear digital signal before applying it to the adaptive filtering unit; and wherein
the processing means of the or each adaptive processing unit comprises a downsampling block for converting the subtracted signal into a downsampled subtracted signal.

13. The system according to claim 11, wherein the processing means of the or each adaptive processing unit comprises:
a band equalizer block configured to receive the filter coefficients from the adaptive filtering unit and to compute, on the base of said filter coefficients, an equalization coefficient; and
first multiplication means for producing an equalized signal by multiplying the subtracted signal by the equalization coefficient.

14. The system according to claim 13, wherein the processing means of the or each adaptive processing unit further comprises:
an output level controller configured to receive the front digital signal, the rear digital signal and the equalized signal and to compute, on the base of said signals, a scaling coefficient; and
second multiplication means for producing a processed signal by multiplying the equalized signal by the scaling coefficient; wherein
the computation of said scaled coefficient includes constraining said coefficient in such a way that an amplitude of said processed signal does not exceed at least an amplitude of the smallest of the front digital signal and the rear digital signal.

15. The system according to claim 11, further comprising:
a front microphone producing a front microphone signal;
a rear microphone producing a rear microphone signal;
a front input channel configured to receive the front microphone signal and to convert it into a front input digital signal;
a rear input channel configured to receive and the rear microphone signal and to convert it into a rear input digital signal; and
applying means configured for applying the front input digital signal to the first input terminal of the or each adaptive processing unit as the front digital signal and the rear input digital signal to the second input terminal of the or each adaptive processing unit as the rear digital signal.

16. The system according to claim 14, wherein:
the digital signal processor comprises:
M adaptive processing units numbered as 1, 2, . . . b, . . . m, where m is an integer equal to or exceeding 2;
a first splitter for splitting the front input digital signal into M frequency subband signals representing front subband signals numbered as 1, 2, . . . b, . . . m and for applying each bth front subband signal to the first input terminal of the bth adaptive processing unit as the front digital signal; and
a second splitter for splitting the rear input digital signal into M frequency subband signals representing rear subband signals numbered 1, 2, . . . b, . . . m and for applying each bth rear subband signal to the second input terminal of the bth adaptive processing unit as the rear digital signal; and wherein
the supplying means is configured for: receiving the processed signal from the output terminal of each adaptive processing unit; combining said processed signals into a processed noise reduced signal; and supplying the processed noise reduced signal to the output means.

17. The system according to claim 11, further comprising:
a mode selector configured for selectively generating either a far talk mode selecting signal or a close talk mode selecting signal, wherein the adapting means of the or each adapting means is further adapted for receiving the selecting signal to trigger the adapting means into a far talk operative mode or a close talk operative mode, wherein:
when the adapting means functions in the far talk operative mode, any of the filter coefficients is nonnegative; and
when the adapting means functions in the close talk operative mode, a sum of absolute values of the filter coefficients does not exceed a predetermined value; and wherein
the or each adaptive processing unit further comprises a mode switch for selectively connecting the first upsampling block to the subtracting means via a first connecting line, when the mode selector generates the far talk mode selecting signal, and via a second connecting line, said second connecting line comprising a delay line, when the mode selector generates the close talk mode selecting signal.

18. The system according to claim 17, wherein:
the digital signal processor comprises:
M adaptive processing units numbered as 1, 2, . . b, . . . m, where m is an integer equal to or exceeding 2;
a first splitter for splitting the front input digital signal into M frequency subband signals representing front subband signals numbered as 1, 2, . . . b, . . . m and for applying each bth front subband signal to the first input terminal of the bth adaptive processing unit as the front digital signal; and
a second splitter for splitting the rear input digital signal into M frequency subband signals representing rear subband signals numbered 1, 2, . . . b, . . . m and for applying each bth rear subband signal to the second input terminal of the bth adaptive processing unit as the rear digital signal; and wherein
the supplying means is configured for: receiving the processed signal from the output terminal of each adaptive processing unit; combining said processed signals into a processed noise reduced signal; and supplying the processed noise reduced signal to the output means.

19. The system according to claim 16, further comprising:
an additional front input channel configured to receive the additional front microphone signal and to convert it into an additional front input digital signal;
an additional rear input channel configured to receive the additional rear microphone signal and to convert it into an additional front input digital signal; wherein
the digital signal processor further comprises:
a first additional splitter for splitting the additional front input digital signal into M frequency subband signals representing additional front subband signals numbered as 1, 2, . . . b, . . . m and for applying each bth additional front subband signal to the first input terminal of the bth adaptive processing unit as the additional front digital signal; and
a second additional splitter for splitting the additional rear input digital signal into M frequency subband signals representing additional rear subband signals numbered 1, 2, . . . b, . . . m and for applying each bth additional rear subband signal to the second input terminal of the bth adaptive processing unit as the additional rear digital signal; and wherein
each bth adaptive processing unit is structured into a first processing block and a second processing block, each processing block comprising:
the first and the second input terminals;
the adaptive filtering unit;
the processing means;
wherein the first processing block further comprises:
two additional input terminals, a first one for receiving the bth additional front digital signal and a second one for receiving the bth additional rear digital signal;
an additional filter means for filtering the bth additional rear digital signal through an application thereto of continuously adaptable filter coefficients;
an additional subtracting means for producing a bth additional subtracted signal by subtracting from the bth additional front digital signal a bth filtered rear signal filtered by the additional filter means;
an additional processing means for optionally performing additional processing of the bth additional subtracted signal; wherein:
the adapting means of the adaptive filtering unit of the first processing block is configured for: receiving the bth rear digital signal, the bth additional rear digital signal, the bth subtracted signal and the bth additional subtracted signal; continuously adapting the filter coefficients in such a way as to minimize an average summary energy of the subtracted signals, while keeping any of the filter coefficients nonnegative; and supplying the adapted filter coefficients to the filter means and to the additional filter means; and
wherein the processing means and the additional processing means of the first processing block are respectively connected to the first and to the second input terminals of the second processing block, the processing means of the second processing block being connected to the output terminal.

20. The system according to claim 19, further comprising an additional front microphone connected to the additional front input channel, and an additional rear microphone connected to the additional rear input channel.

21. The system according to claim 18, further comprising an additional rear microphone located approximately in line with the front microphone and the rear microphone and spaced from the front microphone by a distance approximately equal to a distance between the front microphone and the rear microphone, wherein the additional rear microphone is connected to the additional rear channel and the rear microphone is further connected to the additional front input channel.

22. A noise reduction system, comprising:
output means;
supplying means operatively connected to the output means; and
a digital signal processor comprising at least one adaptive processing unit, wherein the or each adaptive processing unit comprises:
a first input terminal for receiving a front digital signal;
a second input terminal for receiving a rear digital signal;
an adaptive filtering unit comprising:
filter means for receiving the rear digital signal and for providing a filtered rear signal by filtering the rear digital signal through an application thereto of continuously adaptable filter coefficients;
subtracting means for receiving the filtered rear signal and the front digital signal and for providing a subtracted signal by subtracting the filtered rear signal from the front digital; and
adapting means for: receiving the rear digital signal and the subtracted signal; continuously adapting said filter coefficients in such a way as to minimize an average energy of the subtracted signal, while making the sum of absolute values of said filter coefficients not exceeding a predetermined value, and supplying the adapted filter coefficients to the filtering means;
processing means for optionally performing additional processing of the subtracted signal; and
an output terminal functionally connected to the processing means and the supplying means.

23. The system according to claim 22, wherein the or each adaptive processing unit further comprises:
a first upsampling block for upsampling the front digital signal before applying it to the subtracting means;
a second upsampling block for upsampling the rear digital signal before applying it to the adaptive filtering unit; and wherein
the processing means of the or each adaptive processing unit comprises a downsampling block for converting the subtracted signal into a downsampled subtracted signal.
